(19) United States
(12) Patent Application Publication
(10) Pub. No.: US 2007/0297004 A1
(43) Pub. Date: Dec. 27, 2007

(54) INFORMATION-PROCESSING DEVICE, INFORMATION-PROCESSING METHOD, AND INFORMATION-PROCESSING PROGRAM

(75) Inventor: Kinya Honda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/749,955

(22) Filed: May 17, 2007

(30) Foreign Application Priority Data
Jun. 23, 2006 (JP) 2006-173629

(51) Int. Cl. G06F 15/00

(52) U.S. Cl. 358/1.15

(57) ABSTRACT

When generating an output result by using content data and form data of various types, the form data of the same number of types as that of the content data should be prepared and form data adaptable to the current target content data should be selected for every output result. Therefore, an appropriate data field is selected according to the content data, so as to generate an output result desired by a user and decrease a processing load placed on a person who creates the form data.

### BACKGROUND OF THE INVENTION

1. Field of the Invention

The present invention relates to a device, a medium, and a method that are provided, so as to generate form data.

2. Description of the Related Art

Overlay printing may be used to generate and output form data and to insert content data into the form data. First, the overlay printing will be described with reference to FIG. 3. In FIG. 3, processing is performed so that form data 301 and inserted data 303 are overlaid on each other and printed. The form data 301 includes a box 302 to which content data is input, where the term “box” is referred to as a “field” in embodiments of the present invention. The field and the content data are associated with each other. As a result, when the user selects the form data 301 and the inserted data 303, and transmits an instruction to perform the overlay printing, content data of the inserted data 303 is inserted into the field 302 of the form data 301 so that an output result 304 can be obtained.

Further, where the overlay printing and variable printing are performed, inserted data in various forms is obtained from a database, and the inserted data and the form data are superimposed on each other and output.

According to the overlay technology described with reference to FIG. 3, however, a single type of inserted data is adaptable to a single form-data item. Namely, when various types of inserted data is used, as in the case where the overlay printing and the variable printing are performed, the user should prepare form data of the same number of types as those of the inserted data, and select form data adaptable to inserted data which is the current target for every printing. For example, when three types of data items 501, 502, and 503 are expected, as inserted data to be transmitted, as shown in FIG. 4, the user generates form-data items 504, 505, and 506, and selects a form-data item adaptable to the inserted data from among the above-described form-data items 504 to 506 every time the overlay printing is performed.

Therefore, Japanese Patent Laid-Open No. 2006-48533 discloses a technology that can be used, as a method for solving the above-described problems. According to the above-described technology, a plurality of types of templates is generated, and an application program is executed so that an appropriate template is automatically selected from among the templates on the basis of data to be laid out and layout processing is performed.

However, when the form data is selected by using the technology disclosed in Japanese Patent Laid-Open No. 2006-48533, form data adaptable to content data that will be inserted is prepared in advance. For example, when three data items “product name”, “number”, and “amount” are expected, as target data, transmitted data may be any one of the data items, a combination of the data items “product name” and “number”, a combination of the data items “product name”, and “amount”, and so forth. That is to say, the transmitted data may include seven types of combinations of the above-described data items.

Therefore, in this case, a person responsible for generating the form data may be required to prepare seven types of form data, so as to accommodate any one of the seven possible combinations of the three data item types. If the number of the data item types is increased from three to four, the number of possible form data combinations increases to fourteen.

That is to say, when a predetermined number of data items are added to the data items that had already been prepared, at least the predetermined number of templates should be generated and added to the templates that had already been prepared. Since many types of inserted data can be used, so as to perform the overlay printing and/or the variable printing, the number of form data required to be generated by a person responsible for generating the form data may increase significantly.

### SUMMARY OF THE INVENTION

For solving the above-described problems, an embodiment of the present invention allows for selecting an appropriate data field according to inserted data used for performing the overlay printing so that a user can output a desired result and a work load placed on the person responsible for generating the form data is decreased.

According to an aspect of the present invention, an embodiment is directed to an information-processing device generating an output result by defining a data field to which content data is input in form data and inserting the content data into the form data. The information-processing device includes a first setting unit configured to set a use condition under which a data field that should be arranged in the form data is determined for each of a plurality of the data fields, a selection unit configured to select the data field that is to be arranged in the form data according to at least one information item provided, so as to identify a heading of at least one item of content data transmitted, so as to be inserted into the form data, and the set use condition corresponding to each of the data fields, an arrangement unit configured to arrange the selected data field in the form data, and an output unit configured to generate an output result by inserting the at least one item of content data into the data field arranged in the form data by the arrangement unit.

Further features of the present invention will become apparent from the following description of exemplary embodiments with reference to the attached drawings.

### BRIEF DESCRIPTION OF THE DRAWINGS

FIG. 1 shows a system provided, so as to perform processing according to an embodiment of the present invention.

FIG. 2 shows the hardware configuration of an information-processing device.

FIG. 3 illustrates an example output obtained by performing overlay printing.

FIG. 4 exemplarily shows outputs produced on tabular forms by performing the overlay printing.

FIG. 5 shows an example problem that should be solved according to another embodiment of the present invention.

FIG. 6 illustrates another embodiment of the present invention.

FIG. 7 illustrates form-design processing performed according to another embodiment of the present invention.

FIG. 8 illustrates a setting-user interface provided, so as to set a field attribute.

FIG. 9 illustrates a setting-user interface provided, so as to set the attribute of a display area for a table.

FIG. 10 is a flowchart illustrating processing performed according to a first embodiment of the present invention.

FIG. 11 illustrates inserted data according to another embodiment of the present invention.

FIG. 12 illustrates processing shown in the flowchart of FIG. 10.

FIG. 13 illustrates a setting-user interface provided, so as to set a priority order in which fields are decreased in sizes.

FIG. 14 is a flowchart illustrating processing performed according to a second embodiment of the present invention.

FIG. 15 shows the relationships between data fields and display areas.

FIG. 16 also shows the relationships between the data fields and the display areas.

FIG. 17 shows a result of totaling values of the data corresponding to a predetermined field name.

FIG. 18 shows a setting-user interface provided, so as to set details on processing performed according to a third embodiment of the present invention.

FIG. 19 is a flowchart illustrating the processing performed according to the third embodiment.

FIG. 20 illustrates processing shown in a flowchart of FIG. 20.

FIG. 21 illustrates a method of setting attributes in a visual manner.

### DESCRIPTION OF THE EMBODIMENTS

Embodiments of the present invention will be described with reference to the attached drawings.

### First Embodiment

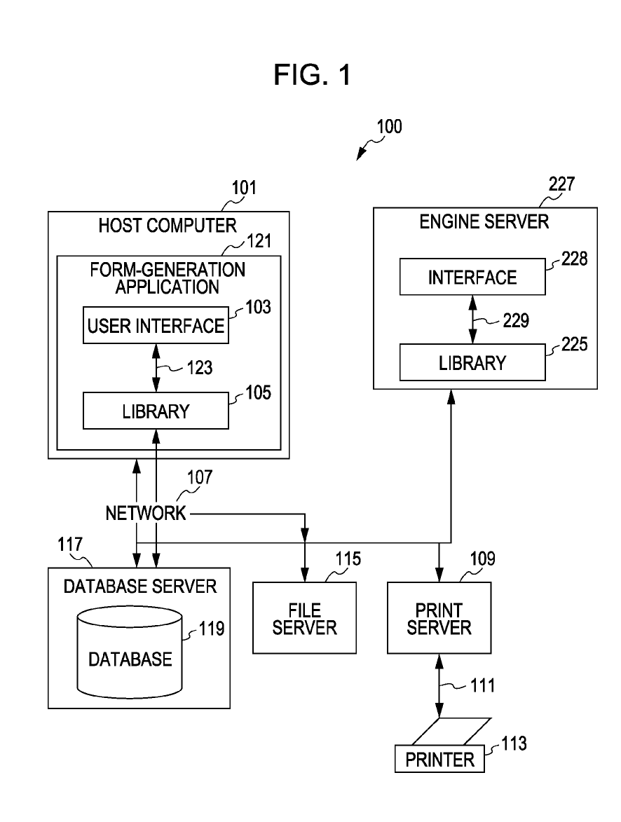

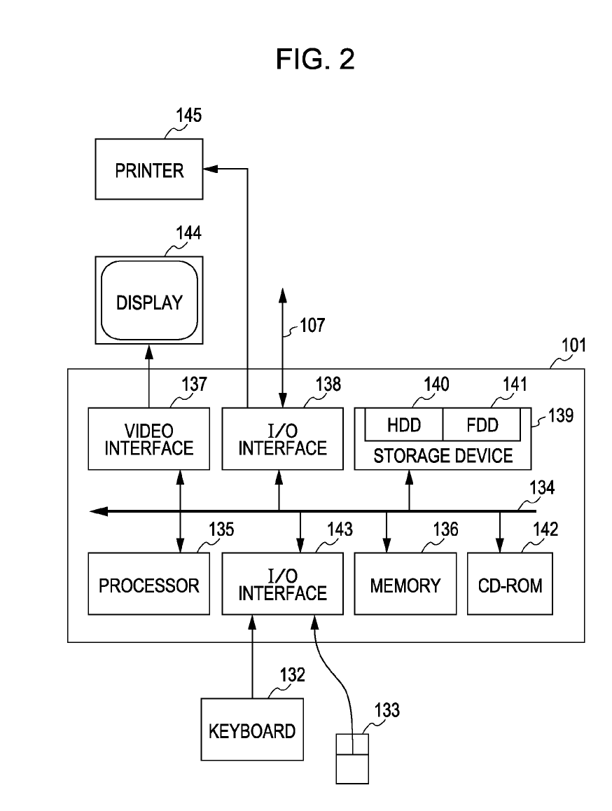

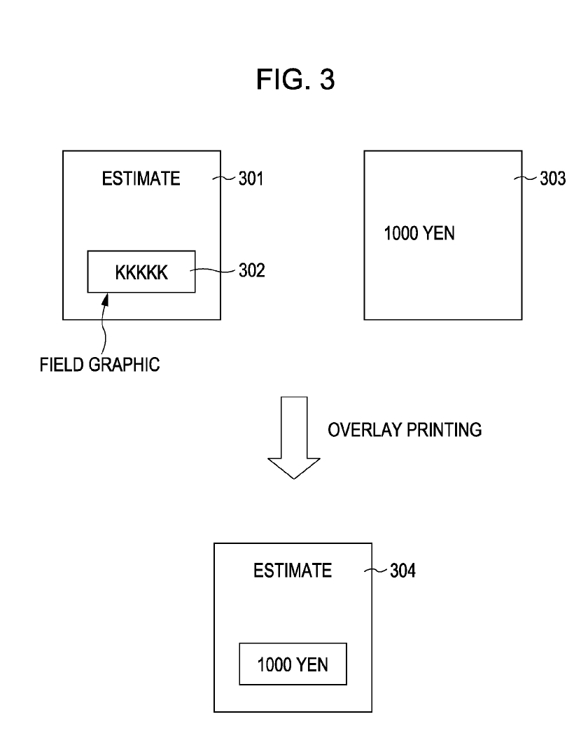

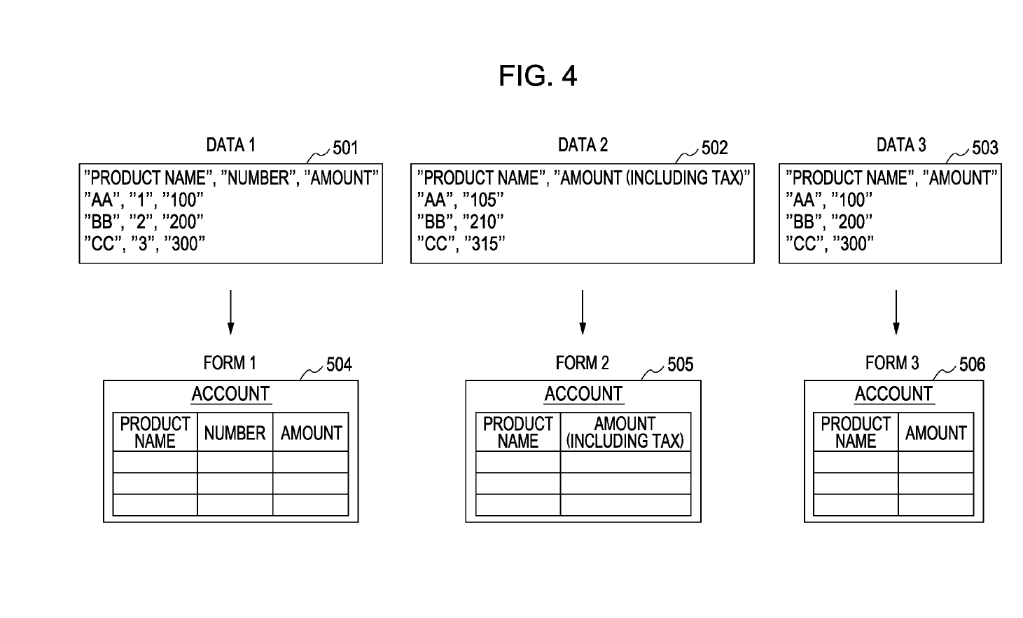

FIG. 1 shows a system 100 for printing data on a form (e.g., business-form paper) or the like according to an embodiment. The system shown in FIG. 1 includes a host computer 101 that will be described in detail with reference to FIG. 2. Particularly, layout editing, setting-file editing, and steps of printing data are performed by the host computer 101.

A software program is stored in a medium, where data stored in the medium can be read by a computer including a storage device that will be described later, for example. The software program is loaded from the computer-readable medium and executed by the host computer 101.

A form-generation application 121 includes two software components. One of the components is a library 105 provided, so as to perform processing including the overlay printing or the like. The other component is a user interface 103 which offers a function provided, so as to make a user generate form data and/or a setting file. The user interface 103 and the library 105 communicate with each other via a communication channel 123. A data source provided, so as to generate a document, is stored in a database 119 of a database server 117. The host computer 101 communicates with the database server 117 via a network 107.

A form-generation application 121 generates form data and/or data on the setting file stored in the host computer 101, or a file server 115 including another computer. The above-described data is stored in either a local-file system of the host computer 101 or the file server 115, or printed by a printer 113. A print server 109 offers a network function to a printer which is not directly connected to the network 107. The print server 109 and the printer 113 are connected to each other via a communication channel 111.

Further, an engine server 227 includes a library 225, which is a separate version of the library 105. The form data stored in the file server 115 and data stored in the database 119 through a library 225 for printing and/or other objects are overlaid on each other and printed. The above-described processing is performed when the user transmits a request to do the processing via the user interface 103, or when the user transmits an instruction to perform the processing to the library 225 via an interface 228. The library 225 and the interface 228 communicate with each other via a communication channel 229.

FIG. 2 shows the hardware configuration of the host computer 101. An input device including a keyboard 132, a pointing device such as a mouse 133, and so forth, and an output device including a display unit 144 and a printer 145 are connected to the host computer 101. An input/output (I/O) interface 138 connects the host computer 101 with other devices via the network 107. The network 107 is typified by a local-area network (LAN), or a wide-area network (WAN). The host computer 101 includes at least one processor 135 and a memory 136 including a random-access memory (RAM) and/or a read-only memory (ROM), for example. The host computer 101 further includes a video interface 137 and an I/O interface 143 used for the keyboard 132 and/or the mouse 133. A storage device 139 includes a hard-disk drive (HDD) 140 and a floppy (registered trademark)-disk drive 141. Though not shown in FIG. 2, the storage device 139 may also include a magnetic-tape drive. A CD-ROM drive 142 is provided, as a nonvolatile data source. The host computer 101 has an operation system (OS) including a GNU's Not Unix (GNU)/Linux, Microsoft Windows (registered trademark), and so forth. The form-generation application 121 is resident in the HDD 140, for example, and executed, read, and controlled by the processor 135. Further, the form-generation application 121 is encoded on a compact disk (CD)-ROM and/or the floppy (registered trademark) disk, and offered to the user. Otherwise, the form-generation application 121 may be installed onto the host computer 101 according to a method different from the above-described method. Namely, the form-generation application 121 may be read from a device or the like operating on the network 107, for example, and installed onto the host computer 101.

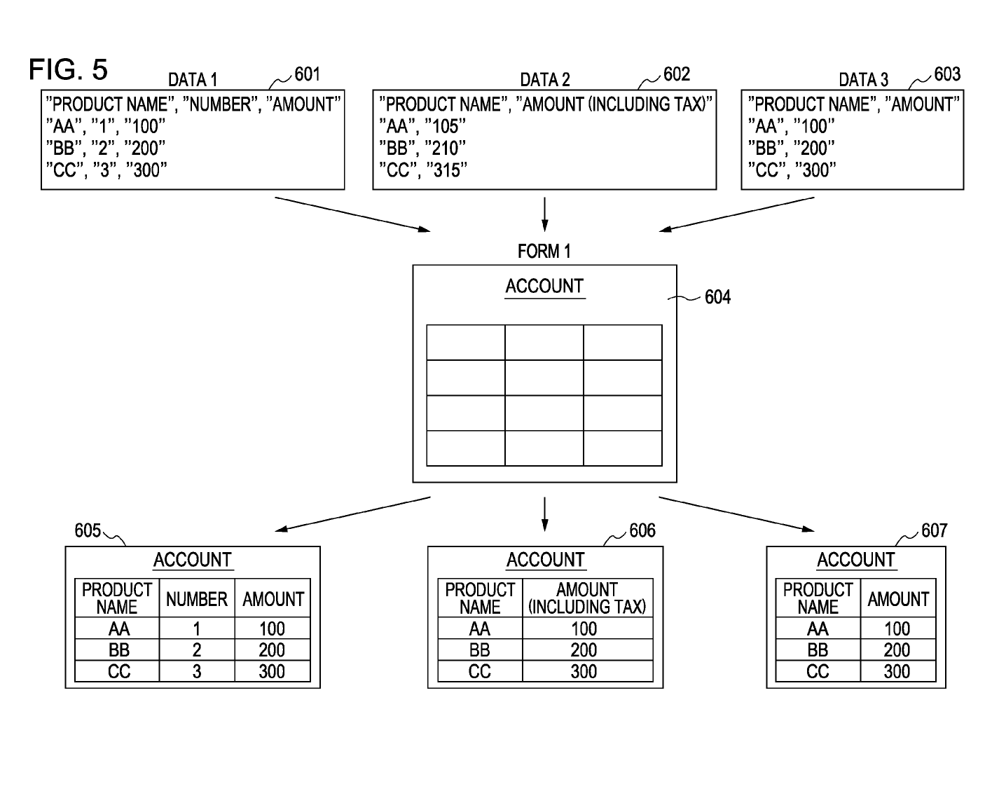

Next, further problems that can be solved according to a first embodiment of the present invention will be described with reference to FIG. 5. For example, a technology to generate the table form alone can be provided, as a method for solving the above-described problems. According to FIG. 5, the table form alone is set on form data 604 and any other information is not set thereon. Therefore, content data of inserted data is simply input from the left column of a table shown on the form data 604. For example, as for content data showing numerical values, the content data corresponding to “amount” shown on each of inserted data 601, inserted data 602, and inserted data 603, the sign ¥ should be added to the numerical value and output, so as to generate an account by overlaying the content data on the form data 604. The above-described problems can be solved by setting the field attribute “Add ¥ to the head of data” for a target field. However, when the form data shown in FIG. 5 is used, for example, the above-described field attribute may not be set, so as to adapt to any type of data input in any of columns. Therefore, the inserted data's worth of form data may not be prepared, which makes it difficult to obtain an output result desired by the user. For example, even if each of the inserted data 601˜603 includes the amount data, each of output results 605˜607 does not show the sign ¥. Further, according to the technology disclosed in Japanese Patent Laid-Open No. 2006-48533, template data for which no use condition is set is prepared, so as to be ready for insertion of content data that does not agree with use conditions set for template data desired by a user. Thus, the preparation of the above-described template data eliminates the need to prepare a large number of form-data items. However, if the template data for which no use condition is set is not the user's choice, it becomes difficult to obtain an output result desired by the user. The first embodiment of the present invention has been achieved, so as to obtain the output result desired by the user by solving the above-described problem.

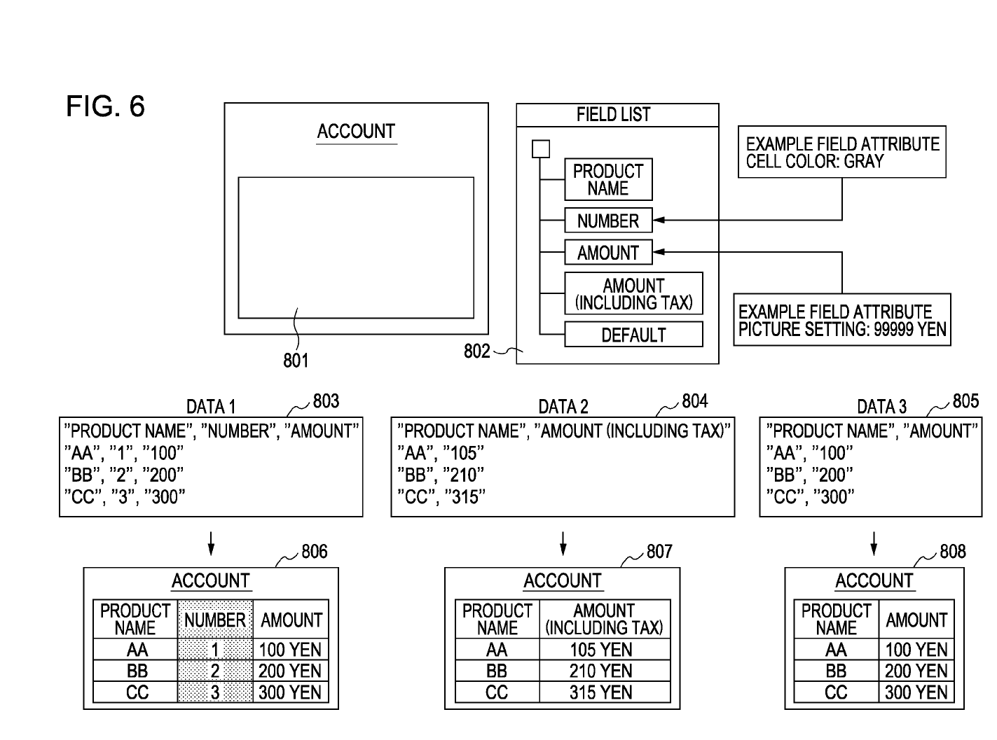

FIG. 6 illustrates processing performed according to the first embodiment of the present invention. In the first embodiment, the form-generation application 121 sets a display area 801 provided, so as to show a table and field data 802 for form data, so as to solve the above-described problem. Then, when inputting content-data items included in inserted data, the form-generation application 121 selects data fields into which the content-data items are inserted on the basis of the heading-identification information (heading name) corresponding to each of the content-data items included in a record. Here, the heading-identification information is provided, so as to identify the heading of a predetermined item of the content data. Next, the selected data fields are arranged in the form data so that output results 806, 807, and 808 are generated.

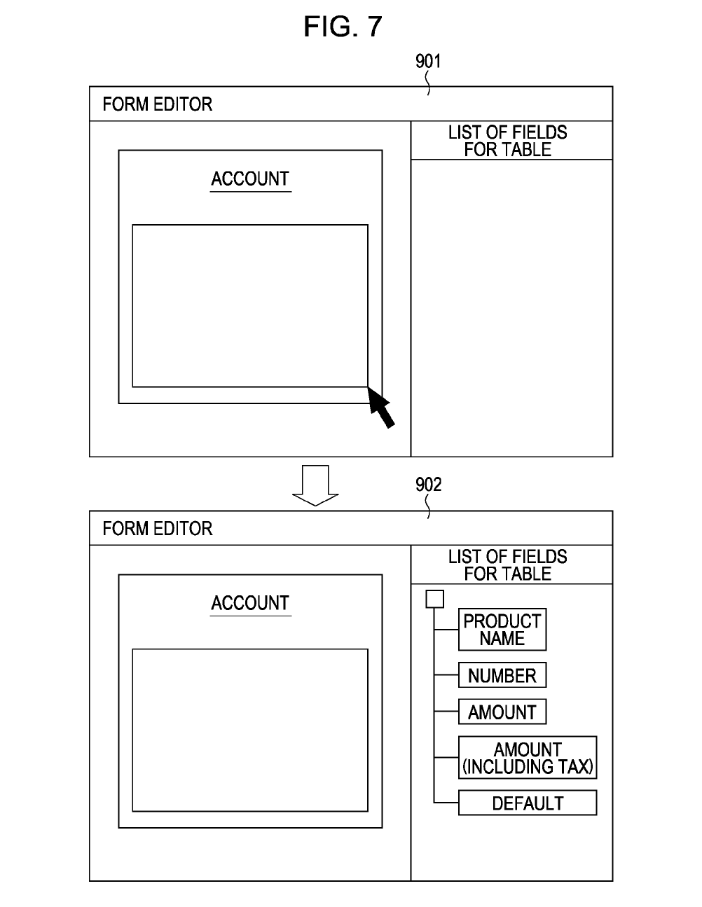

Namely, the form-generation application 121 sets the display area 801 provided, so as to shown the table, on the basis of an area specified by the user, for example, as shown in FIG. 6. Further, the form-generation application 121 generates the field data 802 according to an instruction transmitted from the user. In FIG. 6, field-data items “product name”, “number”, “amount”, “amount (including tax)”, and “default” are set. A field attribute is set for each of the above-described field-data items. The main field attribute shown in FIG. 6 is the field attribute “cell color: gray” set to the field-data item “number”. Therefore, if the inserted data includes data on the field name “number”, the form-generation application 121 can generate an output result showing gray cells relating to the number, as shown in the output result 806. Further, the field attribute “picture setting:¥99999” is set to the field-data item “amount”. Subsequently, if the inserted data includes data on the field name “amount”, it becomes possible to generate an output result showing content data relating to the amount, where the sign “¥” is added to the content data relating to the amount. That is to say, the form-generation application 121 sets the display area where the data fields are arranged and the arrangement attribute provided, so as to determine positions of the data fields on the display area according to information transmitted via setting-user interfaces shown in FIG. 7, 8, and 9. Further, the form-generation application 121 arranges data fields according to the arrangement attribute determined on the basis of information set through the setting-user interface shown in FIG. 9 so that selected data fields are arranged in a set area. According to the first embodiment, the display area 801 and the field data 802 are set for the form data, which makes it possible to generate output results that are dynamically different from one another on the basis of transmitted inserted data. In FIG. 6, data 803, data 804, and data 805 are shown, as the inserted data, for example. However, it becomes possible to easily generate output results differing from one another according to the data types without generating form data for each of the data types.

Next, setting processing performed for the form data will be described with reference to FIGS. 7, 8, and 9. The form-generation application 121 sets the display area provided, so as to show the table according to an instruction entered by the user so that a display area 901 is drawn, as shown in FIG. 7. After the setting of the display area 901 is finished, the form-generation application 121 shows a setting-user interface used for setting a display-area attribute shown in FIG. 9 according to another instruction entered by the user. The setting-user interface (i.e., table-display-area-attribute dialog box 9001) shown in FIG. 9 is provided, so as to enable the user to select the thickness and color of the edge of a box of the display area, a method of arranging fields, the height of rows, and so forth. The arrangement method is provided, as a data item used for determining how the data fields are to be arranged in the display area, where the data fields are determined to be used for the form data. The settings on the row height are made, as a data item used for determining the height of the arranged fields.

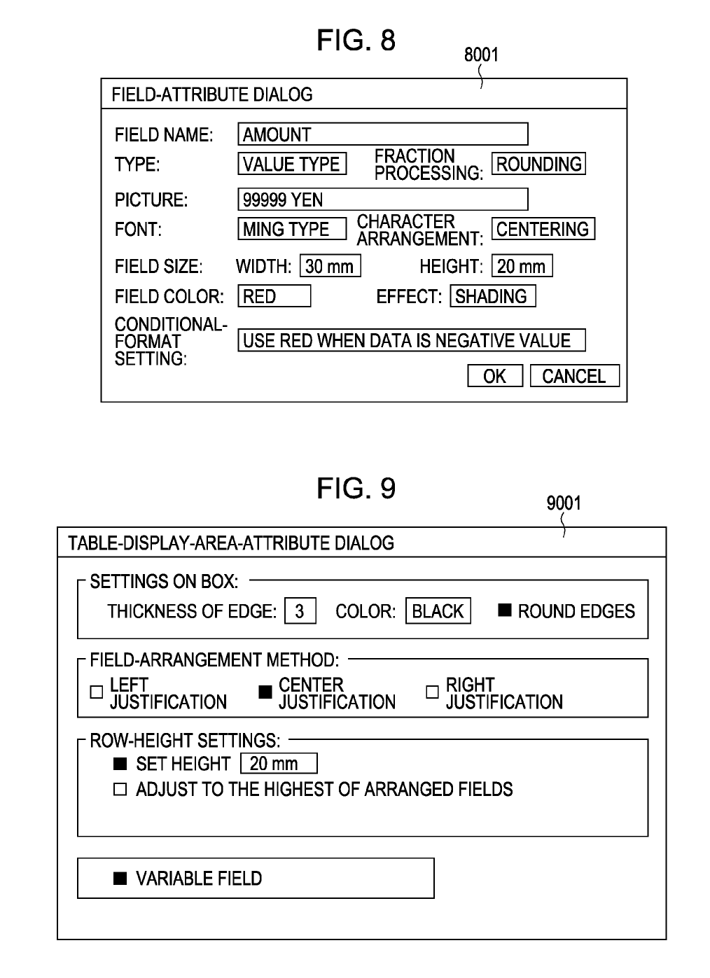

Next, the form-generation application 121 generates a field-attribute-dialog box 8001, as shown in FIG. 8. The field-attribute-dialog box 8001 is provided, so as to enable the user to select a field name and field attributes. Here, the field attribute is generated, as information indicating how an output result is to be made by inserting content data into the data field. Subsequently, the form-generation application 121 generates the form data according to details on the field data. The field name set through the setting-user interface shown in FIG. 8 can be used, as a use condition under which a data field that should be arranged in the form data is determined. The form-generation application 121 sets a field name (use condition) for each of a plurality of data fields according to the information entered through the setting-user interface shown in FIG. 8. Details on the settings made through the setting-user interfaces shown in FIGS. 8 and 9 are shown in a display area 902, as shown in FIG. 7. Further, the memory 136 stores information corresponding to the settings made through the setting-user interfaces shown in FIGS. 8 and 9. According to the display area 902 shown in FIG. 7, field-data items “product name”, “number”, “amount”, “amount (including tax)”, and “default” are set. Here, the field-data item “default” is used for arranging data relating to a field name that does not correspond to any of the field-data items. Further, when data on a field name different from the field-data items “product name”, “number”, “amount”, and “amount (including tax)” is transmitted into the display area 902 shown in FIG. 7, the different field-name data is transmitted into a default field.

As described above, the user sets the display area and the field data, as settings made for the form data. The determination of what fields are arranged in the table in practice is based on the details on the inserted data used for performing the overlay printing.

FIG. 10 is a flowchart illustrating processing performed, so as to overlay the inserted data after the field data is set through the setting-user interfaces shown in FIGS. 7 to 9. Each of steps shown in the flowchart according to the first embodiment is performed by the processor 135 of the host computer 101. The host computer 101 defines a data field into which content data is transmitted in the form data, inserts the content data into the form data, and generates an output result.

The form-generation application 121 associates inserted data selected by the user with the form data, at step S1001. More specifically, the processing corresponding to step S1001 is performed when the user selects inserted data while the display area 902 shown in FIG. 7 is open.

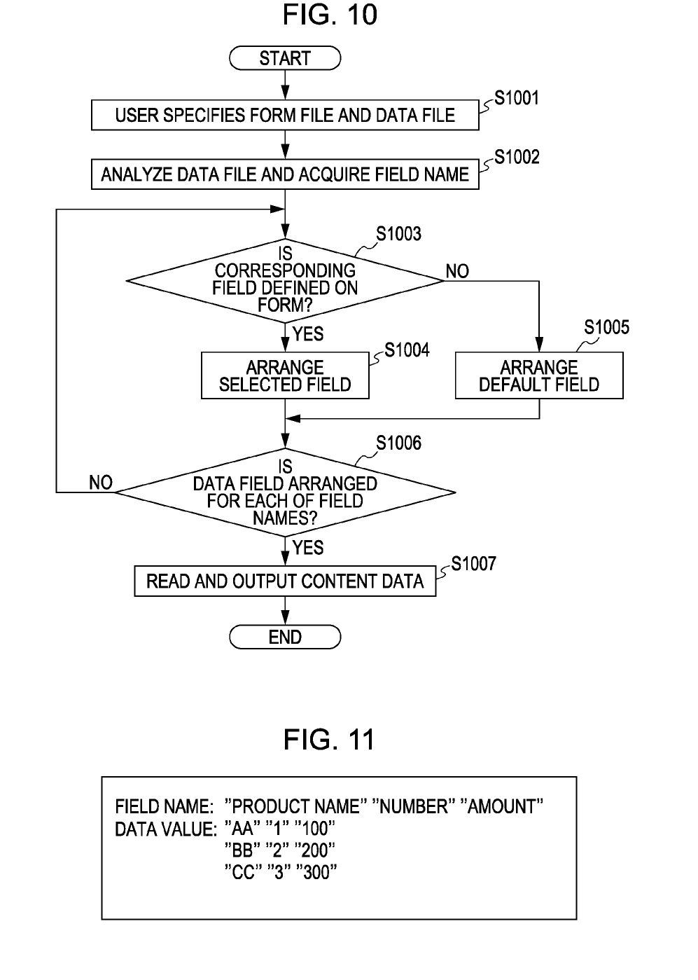

Next, the form-generation application 121 analyzes the inserted data selected by the user and acquires data on a field name, at step S1002. The inserted data includes the field-name data and the content data inserted into the data field so that both the field-name data and the content data can be identified. FIG. 11 shows example inserted data including data on field names “product name”, “number”, and “amount”. The values of data corresponding to the field name “product name” are defined, as “AA”, “BB”, and “CC”. The values of data corresponding to the field name “number” are defined, as “1”, “2”, and “3”. The values of data corresponding to the field name “amount” are defined, as “100”, “200”, and “300”. Namely, since a data attribute is defined for each of data items in the inserted data, the form-generation application 121 can acquire data on the field name. Further, a group of data items including content-data items aligned in a horizontal direction, as shown in FIG. 11, is referred to as a record. According to FIG. 11, a data group including content-data items “AA”, “1”, and “100” generates a single record. Here, each of data items “BB”, “2”, “200”, “CC”, and “3” is also provided, as the content-data item.

At step S1003, the form-generation application 121 determines whether or not the field data corresponding to the field-name data acquired, at step S1002, is set to the form data associated with the inserted data, at step S1001. As described with reference to FIG. 8, the set form information and form-attribute data are stored in the memory 136. Therefore, the form-generation application 121 refers to the form information stored in the memory 136 and compares the form information with the field-name data acquired, at step S1002, so that the processing corresponding to step S1003 is achieved.

If it is determined that the field data corresponding to field-name data which is the current target is not set, at step S1003, that is to say, if the answer is No at step S1003, the form-generation application 121 selects a default field for the current-target field-name data. Then, the form-generation application 121 arranges a data field in a display area provided on the display area 902 shown in FIG. 7 according to the attribute of the default field, at step S1005.

If it is determined that the field data corresponding to the current-target field-name data is set, at step S1003, the form-generation application 121 selects the field data corresponding to the current-target field-name data. Then, the form-generation application 121 arranges a data field in the display area provided on the display area 902 shown in FIG. 7 according to the field attribute, at step S1004. That is to say, the form-generation application 121 performs the processing corresponding to steps S1003 to S1005, so as to identify the heading of each of items of content data transmitted, so as to be inserted into the form data. Then, the form-generation application 121 selects data fields that should be arranged in the form data according to data on field names (use conditions) of the data fields set through the setting-user interface shown in FIG. 8. The arrangement processing performed, at steps S1004 and S1005, will be described. If a predetermined field is selected, a field having the same attribute as that of the selected field is generated. The above-described generated field is a data field into which content data is inserted. If the setting of “variable field” shown in FIG. 9 is on, the form-generation application 121 generates as many data fields as inserted data items. For example, three content-data items relating to the field name “product name” are inserted into the inserted data 803 shown in FIG. 6. Subsequently, the form-generation application 121 arranges a data field for the field name “product name” and three data fields for the three content-data items.

Then, the form-generation application 121 performs the processing corresponding to step S1004 or step S1005, so as to arrange the selected data fields in the form data.

Next, the form-generation application 121 determines whether or not the processing corresponding to steps S1003 to S1005 is performed for each of the field names specified in the inserted data, at step S1006. If it is determined that the processing corresponding to steps S1003 to S1005 is not performed for each of the field names, at step S1006, the processing returns to step S1003. On the other hand, if the processing corresponding to steps S1003 to S1005 is performed for each of the field names, at step S1006, the arrangement of the data fields is achieved before the processing corresponding to step S1006 is performed. Therefore, the form-generation application 121 inserts the content data corresponding to each of data items of the inserted data into the corresponding data field and outputs the content data, at step S1007. When arranging the content data, at step S1007, the form-generation application 121 inserts the content data into the data fields provided for the content data, the data fields being generated through the arrangement processing performed, at step S1004, or step S1005.

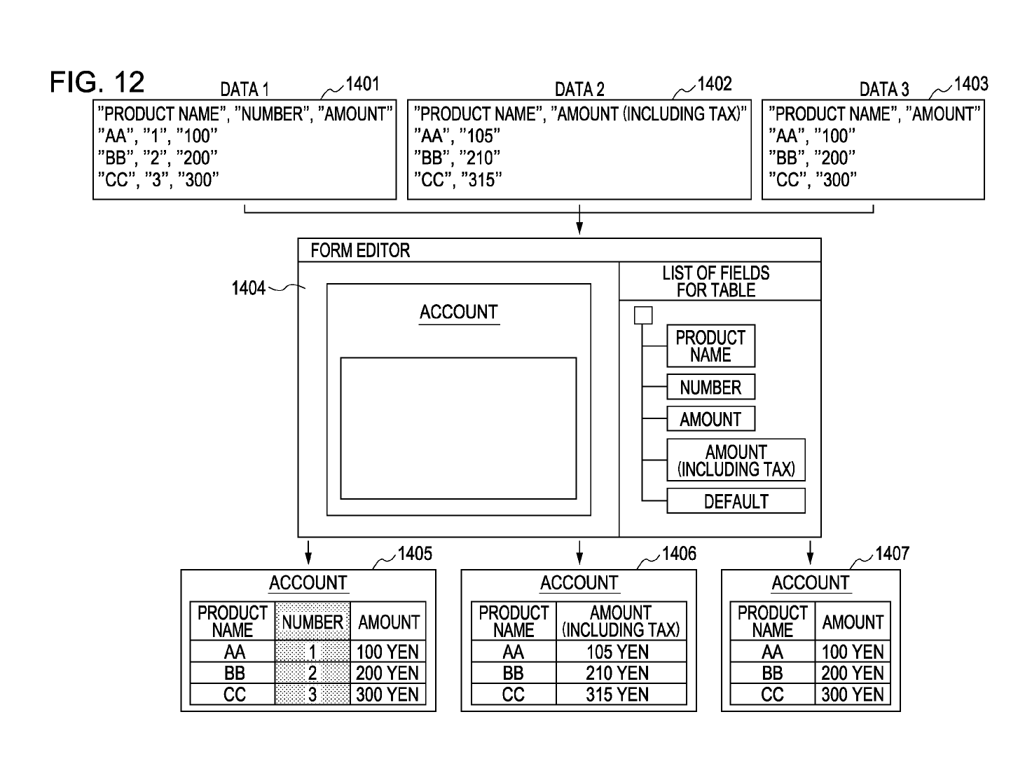

FIG. 12 shows specific example output results obtained by performing the processing shown in FIG. 10.

In FIG. 12, data 1401, data 1402, and data 1403 are selected, as inserted data. Further, the same information as that illustrated in FIG. 6 is set, as the field data and field attribute of the form data.

When the inserted data 1401 and the form data 1404 are associated with each other, the form-generation application 121 acquires data on the field names of the inserted data 1401. Namely, the form-generation application 121 acquires data on the field names “product name”, “number”, and “amount” from the inserted data 1401. Then, the form-generation application 121 determines whether or not the first field-name data “product name” is set, as the field data of the form data, at step S1003. Since the field-name data “product name” is set in the form data 1404, as the field data, the form-generation application 121 arranges a data field used for the field-name data “product name” in the form data according to a field attribute set for the field-name data “product name”. At that time, a data field used for the content data corresponding to the field-name data “product name” is also generated according to the arrangement of the data field used for the field-name data “product name”. As illustrated in FIG. 10, the attribute of the data field used for the content data is the same as that of the data field used for the heading data. Subsequently, the form-generation application 121 also performs the above-described processing for data on remaining field names, and arranges the data fields corresponding to the remaining field names in the form data. The inserted data 1401 includes the remaining field-name data “number” and field-name data “amount”. Therefore, the form-generation application 121 arranges the data fields corresponding to the field names “number” and “amount”, and data fields showing the content data corresponding to the data fields corresponding to the field names in the form data. By performing the above-described processing, the data fields corresponding to all of the field names shown in the inserted data 1401 are arranged in the form data. Therefore, the form-generation application 121 inserts the content data of the inserted data 1401 into the arranged data fields and generates an output result. As for the inserted data 1401 shown in FIG. 12, cells relating to the field name “number⇄ are colored in gray and the sign “¥” is added to each of data items relating to the field name “amount” according to the above-described field attributes. As a result, an account 1405 is generated, for example.

Next, the inserted data 1402 is selected and associated with the form data 1404 so that the processing shown in FIG. 10 is performed, as is the case with the inserted data 1401. As a result, an account 1406 is generated. Further, when the inserted data 1403 is selected and associated with the form data 1404, an account 1407 is generated.

Each of the field attributes is set by using the setting-user interface shown in FIG. 8. However, it is difficult to set some of the field attributes in the field-attribute-dialog box 8001 by using numerical values alone, as is the case where the user tries to set a field attribute relating to the field name “width”, for example.

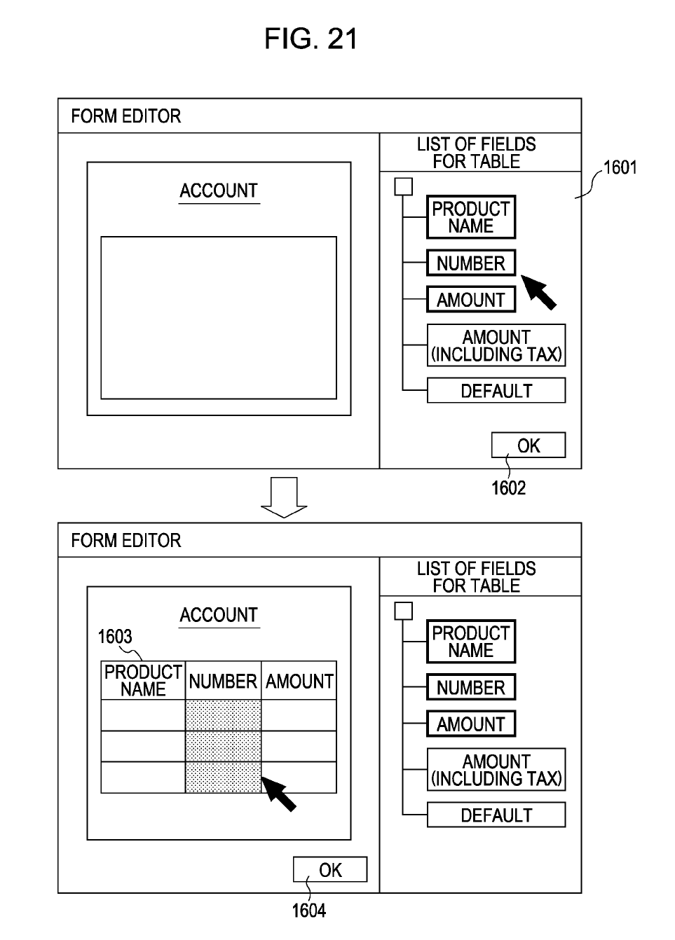

Hereinafter, therefore, a method of confirming the appearance of a table and/or setting an attribute while confirming the table appearance will be described. FIG. 21 illustrates a method of visually setting the attribute. First, the user selects at least one field from a field list 1601. In FIG. 21, three fields “product name”, “number”, and “amount” are selected, for example. When the user presses down an OK button 1602 after selecting arbitrary fields, the selected fields are arranged in a box of a table 1603 according to the attributes of the fields, which makes it possible for the user to confirm the actual appearance of the table 1603. Further, the user can change the field attribute relating to the width, color, and so forth of the field by directly clicking on the table through a mouse, for example. When the user presses down an OK button 1604, the set field attribute affects the corresponding field shown on the field list.

In the past, the form data is generated each time the inserted data is transmitted, which places a significant load on a person generating the form data. However, the first embodiment of the present invention allows for obtaining dynamically different output results according to transmitted data without preparing a plurality of types of form data. According to a technology illustrated in FIG. 7, for example, the user can handle any type of transmitted data. According to the technology illustrated in FIG. 7, however, it becomes difficult for the user to set the field attribute. Therefore, the user can obtain only a single type of output results, which makes it difficult for the user to obtain a desired output result. According to the first embodiment, however, the user can obtain an output result incorporating a field attribute desired by the user.

### Second Embodiment

When the processing described in the first embodiment is performed, an output result desired by the user can be easily obtained according to the associated inserted data. In the first embodiment, however, the table is dynamically generated by associating the inserted data with the form data. Therefore, if the inserted data includes data on many field names, the data fields corresponding to the many field names may not fall within the box of the display area. Therefore, a second embodiment of the present invention illustrates processing performed when it is determined that the inserted data includes the data on many field names and the data fields corresponding to the many field names do not fall within the box of the display area provided, so as to show the table. Hereinafter, the difference between the first embodiment and the second embodiment will be described.

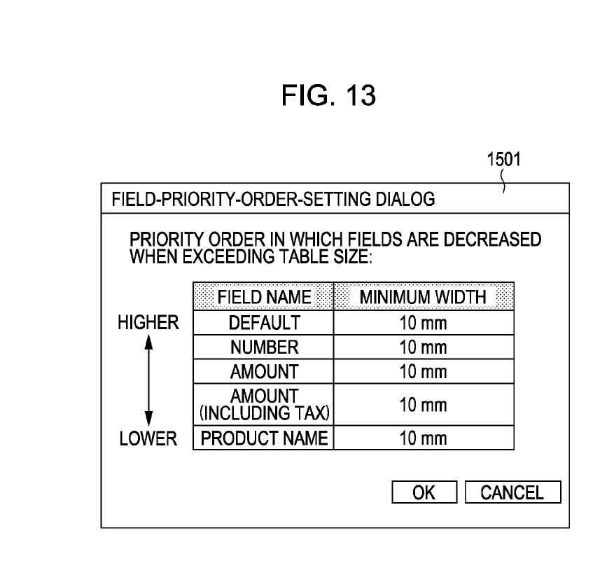

FIG. 13 shows an example dialog box (i.e., field-priority-order-setting dialog box 1501) provided, so as to assign priorities to fields. Here, the priority assignment is performed and the minimum width is set for each of the fields. In the field-priority-order-setting dialog box 1501, for example, the priorities are assigned to the fields corresponding to the field names shown on the list of field names, from highest to lowest. Namely, if two fields do not fall within the table box, the field higher than the other is decreased in size. That is to say, if it is determined that at least two arranged data fields do not fall within the display box, the user can determine which of the data fields should take the priority, so as to be reduced in size, through the setting-user interface shown in FIG. 13.

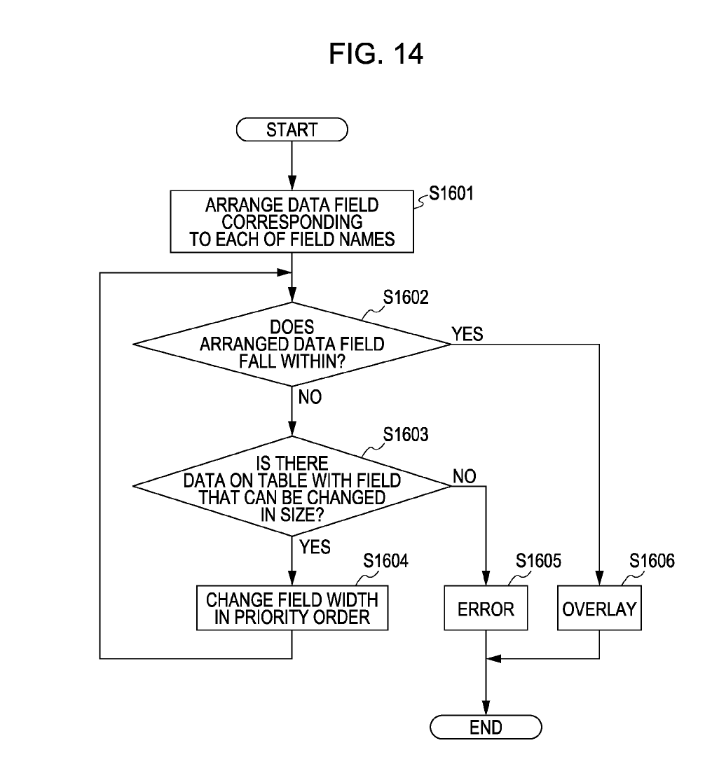

Next, processing performed according to the second embodiment will be described with reference to a flowchart shown in FIG. 14. Processing procedures shown in FIG. 14 are performed when it is determined that the data fields corresponding to all of the field names are arranged, at step S1006 of the flowchart shown in FIG. 10, that is to say, when the answer is yes at step S1006.

The form-generation application 121 arranges the data field corresponding to each of the field names, at step S1601, and determines whether or not the arranged data field falls within the display area, at step S1602. As illustrated in FIG. 8, the field size can be determined by using the setting-user interface provided, so as to determine the field attribute. Therefore, the form-generation application 121 can perform the processing corresponding to step S1602 by comparing the total of field sizes of the data field corresponding to each of the field names with the size of the display area.

If it is determined that the arranged data field falls within the display area, at step S1602, the form-generation application 121 overlays the inserted data and the form data on each other, and outputs the inserted data and the form data overlaid on each other, at step S1606. The term “output” described, at step S1606, denotes producing a display image on the display unit 144 or the like, or transmitting print data to a printer so that the printer prints the print data.

On the other hand, if it is determined that the arranged data field does not fall within the display area, the form-generation application 21 determines whether or not data on a field that can be changed in size exists, at step S1603. As illustrated in FIG. 13, it becomes possible to determine which of the data fields should be changed in size according to the field name corresponding thereto. Further, the minimum width is set for each of the data fields. Namely, the form-generation application 121 can perform the processing corresponding to step S1603 by changing the sizes of the data fields in the priority order and determining whether or not a data field of a size wider than the minimum width that had been set therefor exists.

If it is determined that there is no data field that can be changed in size, at step 1603, that is to say, if the answer is no at step S1603, the form-generation application 121 determines that an error occurs and terminates the processing, at step S1605.

On the other hand, if it is determined that there is the data field that can be changed in size, at step 1603, that is to say, if the answer is yes at step S1603, the form-generation application 121 changes the widths of the data fields arranged in the priority order, at step S1604. That is to say, the form-generation application 121 changes the size of the data field corresponding to a field name to which a high priority is assigned in the priority order set through the setting-user interface or the dialog box 1501 shown in FIG. 13. For example, in FIG. 13, the priority assigned to the field name “default” is the highest of all the priorities. Therefore, the form-generation application 121 changes the size of the data field corresponding to the field name “default” so that the width of the data field is reduced to the minimum width. Then, it is determined whether or not a result affected by the changed size falls within the display area. If it is determined that the result does not fall within the display area, the form-generation application 121 changes the size of the data field corresponding to the next field name on the basis of the priority order.

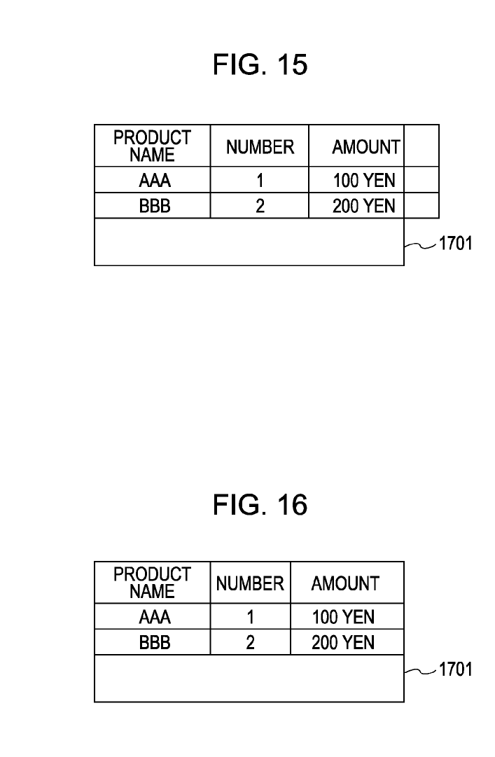

The processing procedures shown in FIG. 14 will be described in detail with reference to FIGS. 15 and 16. In an example shown in FIG. 15, an output result lies off a display area 1701. At that time, the processing procedures shown in FIG. 14 are performed. Further, the priority order showing the order in which the field sizes are changed is set so that that the field sizes are changed in the order of “number”, “product name”, and “amount”. Therefore, the form-generation application 121 changes the size of the data field corresponding to the field name “number” so that the width of the data field is reduced to the minimum width set through the setting-user interface shown in FIG. 13. As a result, an output result of the data field falls within the display area 1701, as shown in FIG. 16. Thus, the sizes of the data fields are changed in the priority order set by the user, so as to be ready for the case where the inserted data includes data on many field names and the output result lies off the box of the display area. In FIG. 14, the field sizes are changed in the priority order that had been set. However, determination of the data field that should be changed in size may be made according to the number of data items actually inserted into each of the data fields, for example. For example, in FIG. 15, a data item inserted into the data field corresponding to the field name “number” is the smallest of all the data items. Therefore, the data fields are changed in size, starting with the data field corresponding to the field name “number”.

The user can select either the data field is reduced in the priority order in which the data fields are reduced or on the basis of the data size through the setting-user interface.

### Third Embodiment

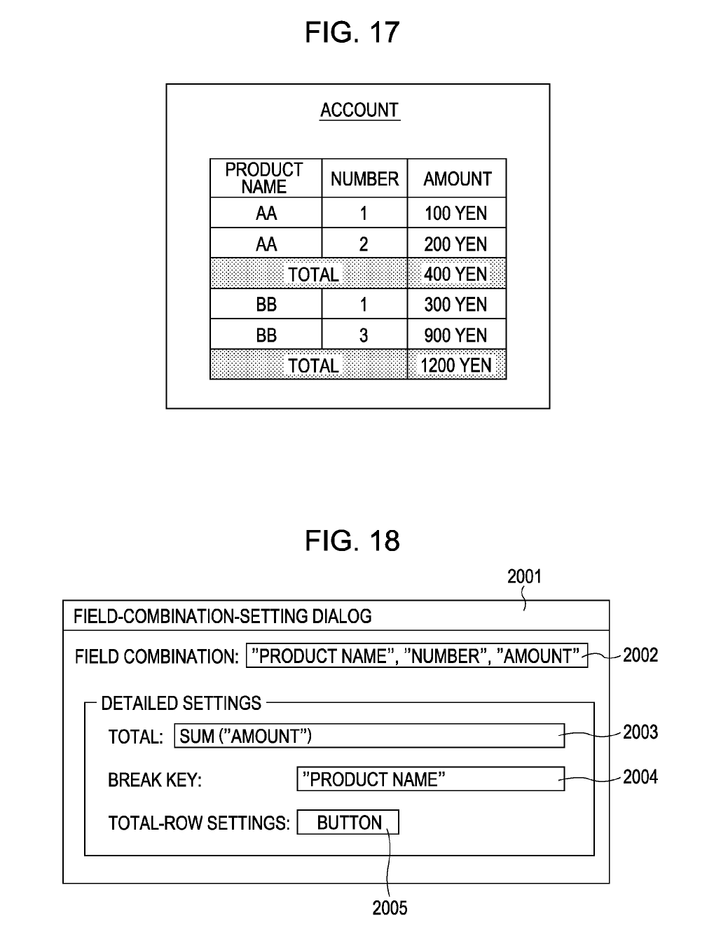

When printing data on business-form paper, the value of the data corresponding to a predetermined field name can be calculated. The above-described calculation is illustrated in FIG. 17, for example. In FIG. 17, data on a total field is inserted into the form data when a change occurs in the field-name data “product name” and values of data items that were shown in the amount fields prior to the change are totaled. As a result, when details on the data corresponding to the field name “product name” are changed from “AA” to “BB”, the total-field data is inserted, and the total of the values of data items that were shown in the fields “amount” prior to the change is calculated, as shown in FIG. 17. Thus, if a change occurs in the value of the content data corresponding to a predetermined data item, the values of content-data items that were shown prior to the above-described change, the content-data items corresponding to a specified data item, are totaled, as described below. Here, the occurrence of a change in the data corresponding to a predetermined data item is referred to as a break. If it is determined whether or not the break occurs in the data corresponding to a predetermined field name alone, the predetermined field name is referred to as a break key. Hereinafter, the difference between a third embodiment of the present invention, and the first and second embodiments will be described.

FIG. 18 illustrates details (i.e., field-combination-setting dialog box 2001) on data which is set, as a field attribute. FIG. 18 shows a setting-user interface provided, so as to generate the table shown in FIG. 17, for example, when inserted data including data on a combination of field names is associated with form data. Here, the combination of the field names is set by the user. The user inputs data on the field-name combination into an item box 2002 and inputs data on a calculation method into an item box 2003. Further, the user can input data on the break key into an item box 2004. Further, the user can set the position where data on the total result is output and the size of the total-result data by specifying a button 2005. Thus, the form-generation application 121 sets conditions under which the total processing is performed according to the values input via the setting-user interface shown in FIG. 18.

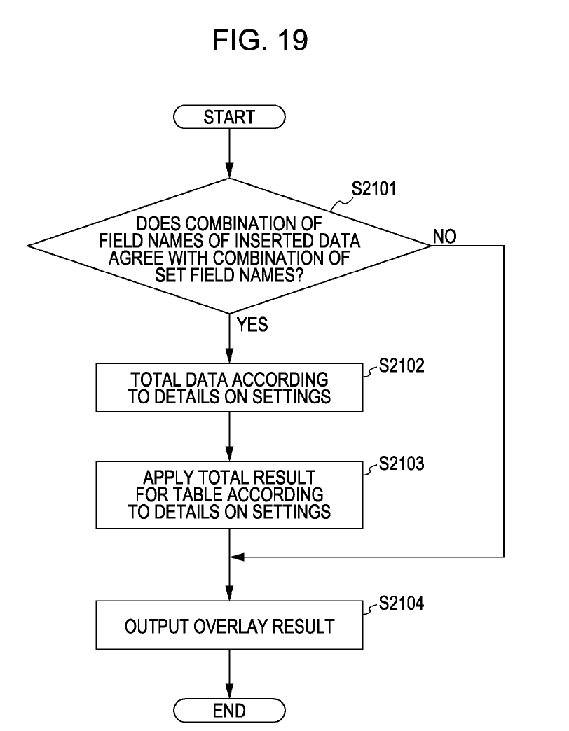

Processing procedures performed according to the third embodiment will be described with reference to FIG. 19.

First, the form-generation application 121 determines whether or not a combination of the field names shown in the associated inserted data agrees with that of the field names set through the setting-user interface shown in FIG. 18, at step S2101.

If it is determined that the above-described combinations do not agree with each other, at step S2101, that is to say, when the answer is no, at step S2101, an overlay result is output by performing the processing procedures shown in FIG. 10, at step S2104.

If it is determined that the above-described combinations agree with each other, at step S2101, that is to say, when the answer is yes, at step S2101, the form-generation application 121 totals the data values according to the settings made through the setting-user interface shown in FIG. 18, at step S2102. The memory 136 stores data on the data item of which values should be totaled, the total method, the break key, and so forth, the data corresponding to the settings made through the setting-user interface shown in FIG. 18. The form-generation application 121 totals the values of the data item for the totaling by performing the set total method according to details on the data stored in the memory 136.

The form-generation application 121 applies the total result obtained, at step S2102, to the generated table according to details on the settings, at step S2103.

The form-generation application 121 inserts data on the total result obtained, at step S2102, into an overlay result and outputs the overlay result, at step S2104.

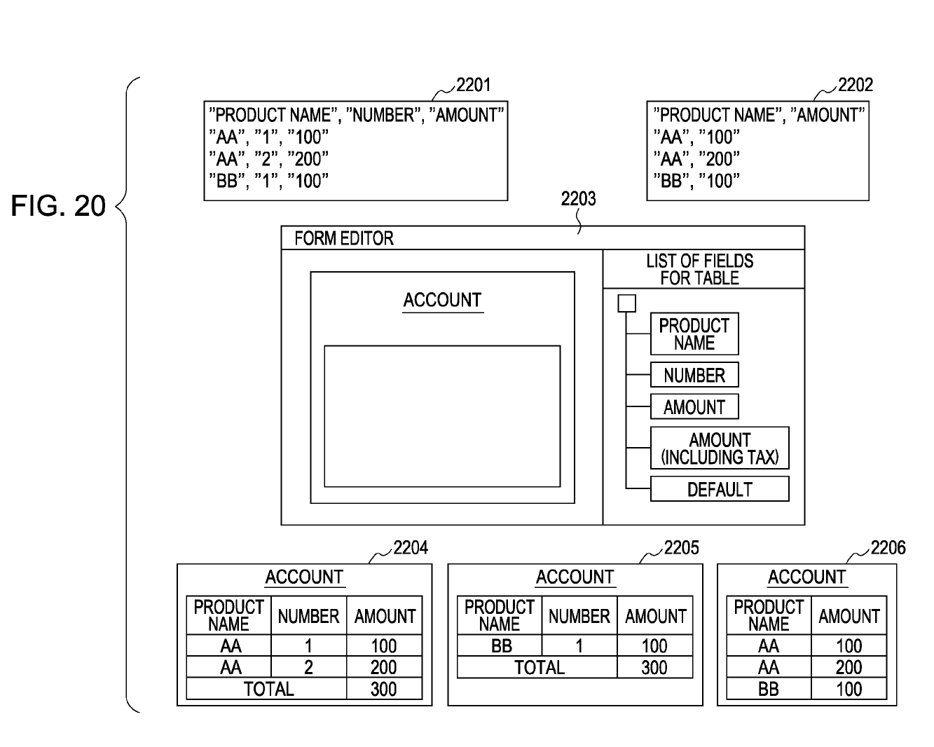

The processing procedures shown in FIG. 19 will be described in detail with reference to FIG. 20. Form data 2203 includes the data input to the setting-user interface shown in FIG. 18. If inserted data 2201 and the form data 2203 are associated with each other, the form-generation application 121 determines whether or not the combination of field names shown in the inserted data 2201 agrees with that of field names set to the form data. In that case, each of the above-described combinations shows the field names “product name”, “number”, and “amount”, and the above-described combinations agree with each other. Therefore, the form-generation application 121 performs the total processing according to value data input to the setting-user interface shown in FIG. 18. According to the setting-user interface shown in FIG. 18, the values of data items corresponding to the field name “amount” are totaled. Therefore, the form-generation application 121 calculates the total of values of the data items corresponding to the field name “amount”. According to the setting-user interface shown in FIG. 18, further, the field name “product name” is determined to be the break key. Therefore, the form-generation application 121 performs the total processing every time a change occurs in the data corresponding to the field name “product name”, that is to say, every time the break occurs, so that accounts 2204 and 2205 are obtained, as output results of the total processing. If inserted data 2202 and the form data 2203 are associated with each other, the combination of field names shown in the inserted data 2202 does not agree with that of the field names set to the form data 2203. Therefore, the form-generation application 121 performs the processing according to the above-described first and second embodiments. Subsequently, no total processing is performed on an account 2206 obtained, as an output result of the inserted data 2202.

Thus, it becomes possible to perform general-purpose overlay printing and overlay printing ready for inserted data including a predetermined combination of field-name-data items by performing the processing procedures according to the third embodiment.

The present invention can be achieved by supplying program code of software implementing the functions of the above-described embodiments to a system or an apparatus directly or from a remote location. According to the above-described embodiments, the program corresponds to the flowcharts shown in the drawings. The present invention can also be achieved by a computer of the system or the apparatus reading and executing the supplied program code.

Therefore, the program code itself installed into the computer, so as to achieve the functions of the above-described embodiments, can achieve the present invention. That is to say, a computer program itself for achieving the functions of the above-described embodiments constitutes the present invention.

In that case, the computer program may be object code, a program executed by an interpreter, script data supplied to an operating system (OS), and so forth, as long as they can function, as a program.

A storage medium for supplying the program may be, for example, a floppy (registered trademark) disk, a hard disk, an optical disk, a magneto-optical disk, a magnet-optical (MO) disk drive, a compact-disk (CD)-read-only memory (ROM), a CD-recordable (R), a CD-rewritable (RW), a magnetic tape, a nonvolatile memory card, a ROM, a digital-versatile disk (DVD) including a DVD-ROM and a DVD-R, etc.

According to another method for supplying the program, the user accesses a home page established on the Internet by using a browser provided in a client computer. Then, the computer program itself achieving the present invention, or a data file that is compressed and that includes an automatic-install function may be downloaded from the homepage accessed by the user to the storage medium including the hard disk or the like, so as to supply the program. Further, the present invention can be achieved by dividing the program code generating the program of the present invention into a plurality of files and downloading the files from different homepages. That is to say, a world-wide-web (WWW) server configured to download a program file achieving the functions of the above-described embodiments by a computer to a plurality of users may constitute the present invention.

Further, the program of the present invention may be encoded and stored in the storage medium such as the CD-ROM, and the storage medium may be distributed to the user. Then, key information used for decoding the encoded program may be downloaded from a homepage via the Internet to a user who satisfies a predetermined condition. Then, the encoded program may be executed by using the key information and installed into a computer, so as to achieve the present invention.

Further, not only by the computer reading and executing the program, but also by the computer executing part of or the entire process by utilizing an OS, etc. running on the computer based on instructions of the program, the functions of the above-described embodiments of the present invention may be achieved.

Further, the program read from the storage medium may be written into a memory of a function extension board inserted in the computer or a function extension unit connected to the computer. Then, the functions of the above-described embodiments may be realized by executing part of or the entire actual process by a central-processing unit (CPU), etc. of the function extension board or the function extension unit on the basis of instructions of the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-173629 filed on Jun. 23, 2006, which is hereby incorporated by reference herein in its entirety.

What is claimed is:

1. An information-processing device generating an output result by defining a data field to which content data is input in form data and inserting the content data into the form data, the information-processing device comprising:
a first setting unit configured to set a use condition under which a data field that should be arranged in the form data is determined for each of a plurality of the data fields;
a selection unit configured to select the data field that is to be arranged in the form data according to at least one information item provided, so as to identify a heading of at least one item of content data transmitted, so as to be inserted into the form data, and the set use condition corresponding to each of the data fields;
an arrangement unit configured to arrange the selected data field in the form data; and
an output unit configured to generate an output result by inserting the at least one item of content data into the data field arranged in the form data by the arrangement unit.

2. The information-processing device according to claim 1, wherein the selection unit selects the data field to which at least one item of content data included in a record is inserted based on heading-identification-information item corresponding to each of the at least one item of content data.

3. The information-processing device according to claim 1, further comprising a second setting unit that is configured to define at least one area where the data field is arranged and that is configured to set an arrangement attribute provided, so as to determine an arrangement position in the defined area, where the data field selected by the selection unit is arranged at the arrangement position, for the form data,
wherein the arrangement unit arranges the selected data field according to the set arrangement attribute so that the selected data field is arranged in the area defined by the second setting unit.

4. The information-processing device according to claim 1, wherein the first setting unit sets an output attribute indicating a manner in which the output result is generated by inserting the content data into the data field, and
wherein the output unit inserts the content data into the selected data field and outputs the form data according to the output attribute.

5. The information-processing device according to claim 3, further comprising a determination unit configured to determine whether or not the data field selected by the selection unit can be arranged in the area defined by the second setting unit,
wherein where the determination unit determines that it is difficult to arrange the selected data field, the arrangement unit changes the selected data field in size, and arranges the changed data field.

6. The information-processing device according to claim 1, further comprising:
a total unit configured to perform total processing, so as to total values of at least one specified item of the content data when a change occurs in a value of the data corresponding to a predetermined heading of the content data, which means that the total unit totals the values that had been shown before the above-described change occurs; and
a third setting unit configured to set a condition under which the total processing is performed,
wherein the total unit performs the total processing when a combination of a plurality of the heading-identification-information items included in the content data agrees with the condition set by the third setting unit.

7. A method for generating an output result by defining a data field to which content data is input in form data and inserting the content data into the form data, the method comprising:
setting a use condition associated with a data field in the form;
selecting the data field that is to be arranged in the form data according to at least one information item provided, so as to identify a heading of at least one item of content data transmitted, so as to be inserted into the form data, and the set use condition corresponding to each of the data fields;
arranging the selected data field in the form data; and
generating an output result by inserting the at least one item of content data into the data field arranged in the form data.

8. The method according to claim 7, wherein the data field is selected based on heading-identification-information item corresponding to each of the at least one item of content data.

9. The method according to claim 7, further comprising:
defining at least one area where the data field is arranged and setting an arrangement attribute provided, so as to determine an arrangement position in the defined area, where the selected data field is arranged at the arrangement position, for the form data,
wherein the selected data field is arranged according to the set arrangement attribute so that the selected data field is arranged in the area defined.

10. The method according to claim 7, further comprising:
setting an output attribute indicating a manner in which the output result is generated by inserting the content data into the data field,
wherein the content data is inserted into the selected data field and the form data is output according to the output attribute.

11. The method according to claim 9, further comprising:
determining whether or not the selected data field is capable of being arranged in the defined area,
wherein, if it is determined that the selected data field is not capable of being arranged in the defined area, the selected data field is changed in size and arranged.

12. The method according to claim 7, further comprising:
performing total processing, so as to total values of at least one specified item of the content data when a change occurs in a value of the data corresponding to a predetermined heading of the content data, which means that the values that had been shown before the above-described change occurs are totaled; and
setting a total processing condition under which the total processing is performed,
wherein the total processing is performed when a combination of a plurality of the heading-identification-information items included in the content data agrees with the total processing condition that is set.

13. A program that is read and executed by an apparatus generating an output result by defining a data field to which content data is input in form data and inserting the content data into the form data, the program causes the apparatus to perform operations comprising:
setting a use condition associated with a data field in the form data;
selecting the data field that is to be arranged in the form data according to at least one information item provided, so as to identify a heading of at least one item of content data transmitted, so as to be inserted into the form data, and the set use condition corresponding to each of the data fields;
arranging the selected data field in the form data; and
generating an output result by inserting the at least one item of content data into the data field arranged in the form data.

14. The program according to claim 13, wherein the data field is selected based on heading-identification-information item corresponding to each of the at least one item of content data.

15. The program according to claim 13, wherein the operations further comprise:
defining at least one area where the data field is arranged and setting an arrangement attribute provided, so as to determine an arrangement position in the defined area, where the selected data field selected is arranged at the arrangement position, for the form data,
wherein the selected data field is arranged according to the set arrangement attribute so that the selected data field is arranged in the area defined.

16. The program according to claim 13, wherein the operations further comprise:
setting an output attribute indicating a manner in which the output result is generated by inserting the content data into the data field,
wherein the content data is inserted into the selected data field and the form data is output according to the output attribute.

17. The program according to claim 15, wherein the operations further comprise:
determining whether or not the selected data field is capable of being arranged in the defined area,
wherein, if it is determined that the selected data field is not capable of being arranged in the defined area, the selected data field is changed in size and arranged.

18. The program according to claim 13, wherein the operations further comprise:
performing total processing, so as to total values of at least one specified item of the content data when a change occurs in a value of the data corresponding to a predetermined heading of the content data, which means that the values that had been shown before the above-described change occurs are totaled; and
setting a total processing condition under which the total processing is performed,
wherein the total processing is performed when a combination of a plurality of the heading-identification-information items included in the content data agrees with the total processing condition that is set.
